(19) United States
(12) Patent Application Publication
(10) Pub. No.: US 2008/0294626 A1
(43) Pub. Date: Nov. 27, 2008

(54) Method and apparatus for leveraged search and discovery - leveraging properties of trails and resources within

(76) Inventor: Amarnath Mukherjee, San Jose, CA (US)

Correspondence Address: CLARIFYRE, INC.;ATTN: AMARNATH MUKHERLEE, 1230 SAN TOMAS AQUINO RD., # 320, SAN JOSE, CA, 95117, US

(21) Appl. No.: 12/075,434

(22) Filed: Mar. 10, 2008

Related U.S. Application Data
(60) Provisional application No. 60/905,698, filed on Mar. 8, 2007.

(51) Int. Cl. G06F 7/06; G06F 17/30

(52) U.S. Cl. 707/5; 707/E17.014

(57) ABSTRACT

A method of automatically extracting knowledge from user generated trails. The method of this invention provides:
(a) a collection of trails, each comprising a collection of resources; resources include URLs, documents, computer files, images, database objects, videos, music, emails, or a combination of these; a resource may also be a collection of other resources. Resources and trails may optionally have additional meta-data associated with them.
(b) computer programs that identify the following:
(b.1) given a trail, resources that are not contained within the trail, but are nevertheless related to the contents of that trail;
(b.2) resources that have an affinity to each other (e.g., “similar urls”) regardless of which trails they belong to;
(b.3) resources that are dissimilar (e.g., low or negative affinity), regardless of which trails they belong to.

The system also lets users search for resources and trails shared by other users, and/or shared with specific groups.

### RELATED APPLICATIONS

This application claims benefit of priority to U.S. Provisional Application No. 60/905,698, filed Mar. 8, 2007, entitled “System and Method for Reusing Experience,” naming Amit Das, Amarnath Mukherjee, Mamta Sharma, and Ravindra Sharma as inventors. The aforementioned priority application is hereby incorporated by reference.

### BACKGROUND

1. Field of the Invention

The present invention relates to relates to enhanced search and discovery of web and non-web resources. In particular, the present invention relates to a method and apparatus for leveraged search.

2. Related Art

Finding resources that are relevant from a vast distributed repository such as the Internet has been an important problem in the past decade. The early search engines used word-frequency counts to determine which results to return first on a search, but their quality of results in terms of relevance was poor. Next came Google's PageRank which assigned the concept of review for a page by other web-publishers (were other websites linking to that page?). Following that, came a number of user-powered review ideas, e.g., StumbleUpon and Delicious, where users rated pages they liked (or did not like), and other users were able to see these ratings.

Relevance has also been inferred by mining click streams. More recently, there have been a number of systems that have introduced the idea of trails or notebook [Experuse (our system), Trailfire, Trexy, Google-Notebook]. While they differ significantly in details, the essence is that users collate related resources into trails, and either keep them private or make them available to others. The degree of control that users have in sharing trails, as well as what a trail may contain differ significantly in these systems, but those details are tangential to the current discussion.

While click streams provide valuable data for mining related-resources, and improving search results, they are noisy. In contrast, since trails are created by humans to explicitly collate related resources, these resources may be considered higher quality, and hence trails offer a newer, cleaner dataset for determining related-content.

Trails also offer users new ways to discover relevant content that others may have discovered. This paper describes these new avenues.

### SUMMARY

According to embodiments described herein, techniques are provided for finding new resources (such as web pages), and improving search experience.

Trails may be used to find new resources that were hitherto very difficult to locate. They let users who may not have known each other collaborate with each other based on trails they have created.

Also, for any given resource, trails enable finding related resources with a high degree of accuracy. The invention described here not only provides these, it also enables users search a shared-repository, limiting the results returned to those their trusted friends and trusted groups recommend. This allows for a significantly better search experience.

More formally:

A method of automatically extracting knowledge from user generated trails is presented. The method of this invention provides:
(a) a collection of trails, each comprising a collection of resources; resources include URLs, documents, computer files, images, database objects, videos, music, emails, or a combination of these; a resource may also be a collection of other resources.
(b) new trails that are added to the collection of trails in (a) by external agents (such as users).
(c) new resources that are added to trails by external agents.
(d) existing resources that are added to, or removed from trails by external agents.
(e) existing trails that are removed from (a) by external agents.
(f) ratings on trails and resources within as provided by external agents.
(g) a trail could be sub-trail of one or more trails, and
(h) computer programs that identify the following:
   1. given a trail, resources that are not contained within the trail, but are nevertheless related to the contents of that trail.
   2. resources that have an affinity to each other (e.g., “similar urls”) regardless of which trails they belong to.
   3. resources that are dissimilar (e.g., low or negative affinity), regardless of which trails they belong to.

The system lets users discover new resources based on one or more trails they identify as of-interest to them. It also lets a computer search program decide which URLs (and other resources) are potentially related and which are potentially unrelated. This data may be used for:
(a) showing similar resources for a given resource.
(b) ordering search results—e.g., it's desirable to return highly ranked but dissimilar URLs on a search result.
(c) showing related trails for a given resource.
(d) showing related trails for a given trail.
(e) showing related resources for a given trail.

The system also lets users search for resources and trails shared by other users, and/or shared with specific groups, and/or shared with specific users. It lets users specify the shared users and groups with a simple notation that extends current search engine expressions.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 illustrates a Trail as a collection of resources.

FIG. 2 illustrates a resource.

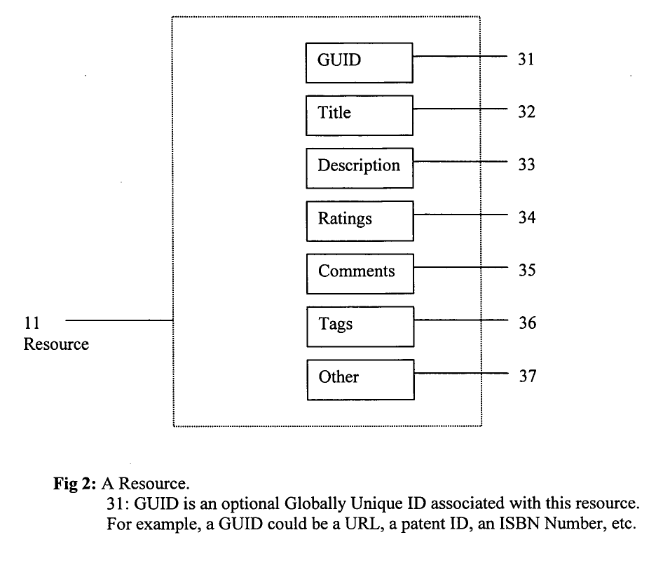

FIG. 3 illustrates Comparing two trails with overlapping resources.

FIG. 4 illustrates a Trail Overlay Map.

FIG. 5 illustrates a Split Pane View.

FIG. 6 illustrates Search Results for search term: bass

### DETAILED DESCRIPTION

A method and apparatus for leveraged search using trails is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Introduction

Consider the following scenarios:

[Scenario 1]

Jane does not have medical training, but her cat has been diagnosed with cancer, so she has been doing research in feline leukemia. She has researched the Internet, and has found a number of useful resources. While these resources have been helpful, she has not yet found a solution that works for her cat. Her doctors are not giving her hope, so she is researching the Internet furiously for any last straw she can find. However, the Internet search engines keep returning the same resources she has seen before.

In another part of the world, Joe has been doing the same research on feline leukemia. It turns out, he has found some resources that would have helped Jane. However, Joe and Jane do not know each other, and Joe currently does not know that Jane could have used his research.

Using the concept of Trails, Jane can discover resources found by Joe, and vice-versa.

[Scenario 2]

Geoff is an entrepreneur in the technology field. It's important for him to keep track of his competition. However, he finds it difficult to find out about new competitors entering his field of business.

Gladys, Helen, and Mark have interest in the same products that Geoff sells. As part of their research, they create trails listing suppliers they like. If Geoff could locate these trails, he could not only learn about his current competition, he could also keep track of new data that Gladys, Helen, and Mark add to their respective trails.

Geoff will benefit from a system that will enable him to create a trail that has the following data: (a) union of resources from trails he has found useful—e.g., those from Gladys, Helen, and Mark; (b) other resources that he finds from time to time. Also, the system could send him alerts when a new entry was added to one of the containing trails.

Improving a Search Engine with Trails

In the early days of Internet Search Engines, people's expectations were low. If a Search Engine (SE) returned a useful result, it was doing very well. Currently, however, people's expectations of SEs is high, and one expects to get useful results for whatever they are searching for.

The difficulty is, it's not always clear to SEs what a user is really interested in, based on a search phrase. For example, if a user searches for “bass,” is she interested in bass fish, or bass guitar, or bass ale?

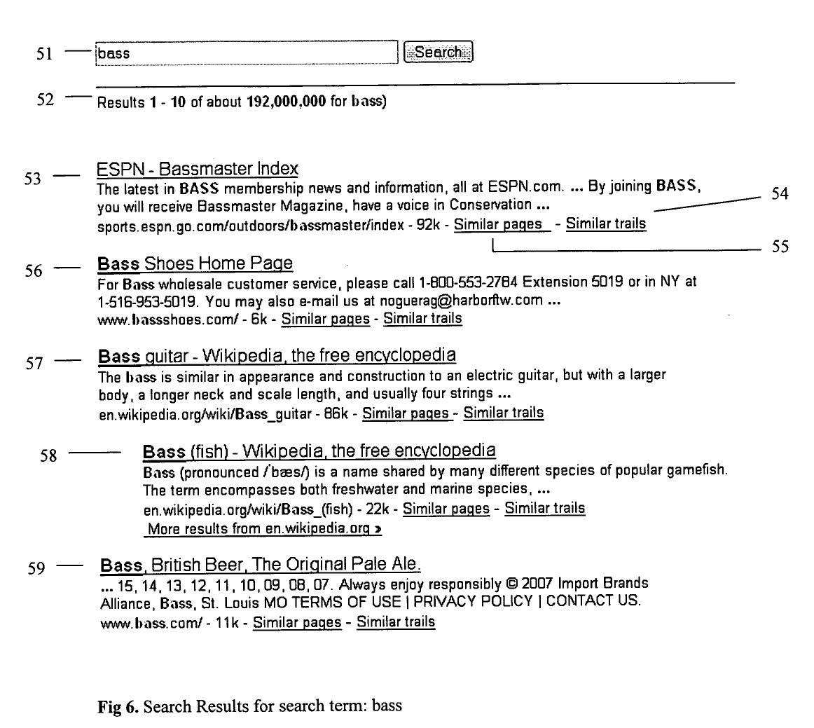

Search Engines may have literally millions of entries in their index matching “bass” (e.g., see FIG. 6, number 52). One strategy is to provide results from all three categories (bass fish, bass guitar, and bass ale) on the first page of results—i.e., provide as many different types of results as possible on the first page of results, so that the likelihood of a user finding a useful resource is increased (e.g., see FIG. 6, numbers 53, 56, 57, 58, 59).

However, how does an SE know which pages are similar, and which are different? One approach is to analyze search terms in the SE's logs. If people have searched for “bass fish” and “bass guitar” and “bass ale,” one could reasonably assume that fish, guitar, and ale are three different types of results associated with bass. Another approach is to analyze user-created trails (described below).

In addition to providing different results, SEs may also decide to show similar pages for each search result. How does an SE know which URLs are “similar” to a given URL?

Clicking through “Similar Pages” links on current SEs such as Google, Yahoo, Microsoft, Ask, etc., it's clear that their results for “similar pages” are weak. In many cases, they are not very similar at all.

Here too, as shown below, trails can help.

### Terminology

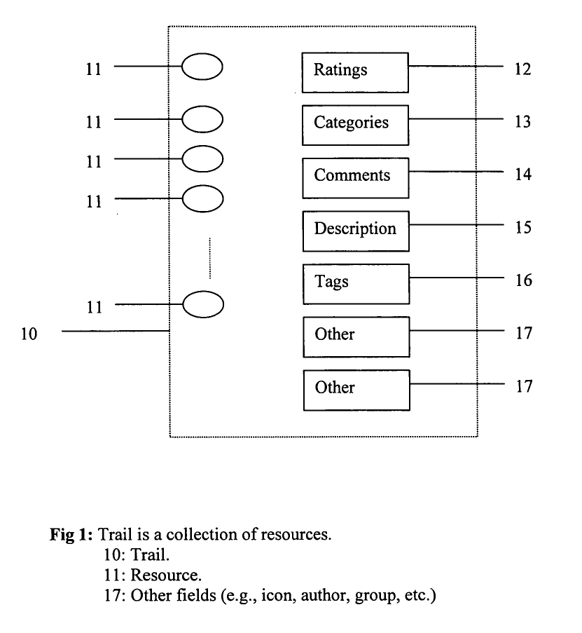

Trail: A trail is a collection of related resources, see FIG. 1. In the current embodiment, trails are explicitly created by humans, and resources are added to them either explicitly (on-demand), or automatically as a user browses through different pages. The objective is to group related information into trails, much like one saves related files in a folder. We have implemented trails in our system (experuse); so also has Trailfire, Trexy, and Google Notebook.

Resource: A resource is any piece of information that adds value to the trail. For example, it could be a URL, an email, a note, a document, or a collection of other resources. In addition, a resource may have a title, a description, ratings, comments, tags, and other fields. If the resource is a URL, the URL will serve as its globally unique id (GUID). If the resource is a patent, the GUID will be the patent id. If the resource is a book, the GUID will be it's ISBN number. Some resources, such as notes entered by users, may have no distinguishing GUIDs—or they may be assigned a unique id by the system.

Example Trails and their Resources

Consider a trail on “Patent Writing Tips” that someone starting to write a patent might create. It may have resources (URLs, notes, emails, documents, etc.) on topics such as:

How to write claims.

How to write a detailed description.

Book: “Patent It Yourself.”

Patent search page (which is a bookmark).

Notes.

In addition, it may have tags, categories, comments, ratings, etc. provided by users who have access to this trail (including the trail creator).

A different trail on “Patent Filing” may have resources for the following:

Fees: US

Forms: US

Fees: Europe

Forms: Europe

A third trail on References for a patent application might have the following:

reference-1: unique-Id=patent-id=patent://patent-number-1

reference-2: unique-Id=patent-id=patent://patent-number-2

reference-3: unique-Id=URL=http://foo.com/xyz

reference-4: unique-Id=ISBN=isbn://isbn-number

reference-5: unique-Id=product-sku=sku://sku-number

etc.

Here patent://patent-number, isbn://isbn-number, are simply notations. Any alternative notation may be used to achieve the same purpose. For example, it could be a URL of the following form: http://xperuse.com/resource.htm?type=patent&country=US&number=123

### Discovering New Information by Comparing Trails

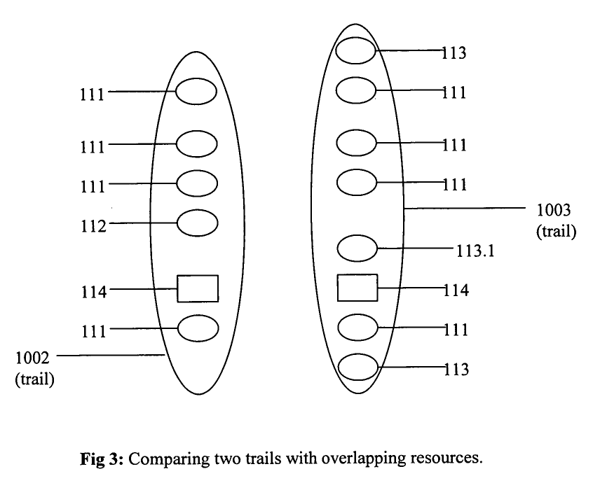

Please refer to FIG. 3. In this figure,
Ellipses identified as 1002 and 1003 are trails (collection of resources).
Resources common to the two trails are marked 111.
Resources present in Trail 1002 only are marked 112.
Resources present in Trail 1003 only are marked 113.
113.1 are resources present in Trail 1003 only, and have been marked un-interesting by other users (or robots) when comparing Trails 1002 and 1003. Once that happens, it's remembered as part of 1002 as uninteresting, and this is shown at 114.

Suppose Jane in our first example had created or knew about Trail 1002 in FIG. 3, the system will help her with the following:
locate one or more trails, 1003, that have overlapping resources;
identify resources 113 that Jane is unaware of, i.e., Jane will be able to discover new resources based on a trail she has created or found (Trail 1002), and other trails created by other users and/or auto-generated using data mining algorithms.

When inspecting the new Trail, 1003, Jane may mark a resource as uninteresting (113.1 in FIG. 3). In such a case, it will be remembered as uninteresting (114 in FIG. 3) for one or more of the following cases:

for User Jane and Trail 1002, and/or

for all users, Trail 1002, and/or

for User Jane, all trails, and/or

for all users, all trails.

Viewing Related Trails with a Trail Overlap Map

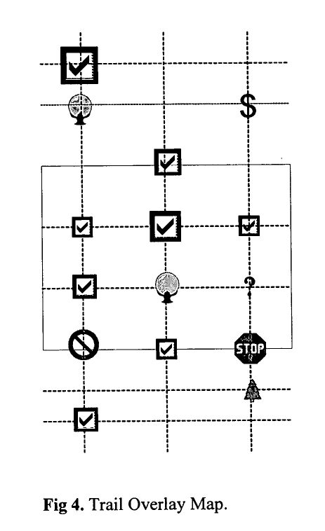

A trail overlay map provides a visual comparison of related trails. Each trail is a string of nodes (resources) arranged along the y-axis, see FIG. 4.
Nodes have color, shape, and size to indicate various attributes. In the example (FIG. 4), two nodes are displayed as light bulbs, implying that they provided superior understanding of the subject matter. Another user has marked the same node with a question mark, implying they were unclear about something on this page. The stop sign may be a way to mark a resource negatively. Node shapes and icons may also be industry specific. For instance, the $ sign may indicate potentially good investment information, a tree may indicate the node is about the environmental sector, etc.
The trail's line-thickness (vertical line) and/or color may indicate its overall rating.
Let us call the trail in focus (the one that is of central interest to the user) the main trail. The main trail may be plotted on a 2D plan with the vertical line x=0. In FIG. 1, the main trail is the one in the center.
Related trails: a related trail will most likely have nodes with GUIDs that are common with the main trail. It may have other resources that are not part of the main trail.
A related trail may be shown as a vertical line parallel to x=0, e.g., x= . . . , −2, −1, 1, 2, . . . Nodes that are common (same GUID) will line up with those of the main trail. In general, for any horizontal line Y=y, all nodes that intersect it refer to the same resource. If a resource can be identified with multiple URLs, and a duplicate detection algorithm identifies them as one and the same content, the system may assign them the same GUID.
As shown in FIG. 4, the same node may have different ratings and interpretations in different trails. This is because each user creating her trail has own her evaluation of a node.
When a user mouses over a node, information pertinent to the node will be displayed. For example, user comments, rating, how many people viewed this node in the last week (or some other period), etc. may be shown.
A box demarcates the resources that belong to the main trail; all nodes in related trails outside the box constitute data that is not part of this trail. This way, the user can easily see which other nodes may be useful. The color code and size are provided to aid the user in her decision making process.
The number of trails shown can be controlled by the user with a slider-scale.

Displaying this data is best done with an (x,y) plotter, as follows:
Let the collection of resources amongst the trails of interest be {U}. Let the trails of interest be {T}.
Assign each resource, ui in {U} that has a GUID, a distinct value, Y=yi.
Assign each trail in {T} a unique value, X=xi.
For each trail, e.g., Ti, plot {X=xi, Y}.
Optionally, add lines through the points of each trail.

### More On The Trail Overlap Map

Properties of Trail Overlay Map:
The system lets users control the trail-density, i.e., how many trails are shown on the map, with a slider scale/knob.
It's personalized—for example, one may specify that:
   The user's own related trails are always shown, unless one chooses to over-ride this option for specific scenarios.
   Trails from specific groups/people are “in”—subject to ratings, relevance, and other preferences.
   Trails from specific people or groups are not “in”—i.e., user is censoring certain people or groups, and is not interested in seeing their trails.
   Trails that are marked with a specific tag, or attribute/value pairs, or classified into certain categories are not “in.” The classifications may be done by self, selected people or group, or the public as a whole. An example of such classification is adult trails.
   Parental controls, e.g., let parents censor adult trails for their kids.
Public trails are shown if they are related, filtered by ratings.
Trails may be filtered by tags, values of specific attributes (e.g., date-range), search terms, categories/themes.

Trails are collections of URLs in most cases. However, they may be refined to be something else, e.g.,
While researching domain names, the collection's elements are domain names searched.
While researching medical diagnostics, each symptom and/or laboratory-data-component may be a collection entry. The data may be gathered and coalesced from several sources.

FIG. 4 shows which resources are missing from user's main trail (the trail that is the user's focus).

Nodes are resources. Those that are aligned horizontally are the same resource.

The main use of this data is to easily see which resources are missing from the current trail.

### Split Pane View

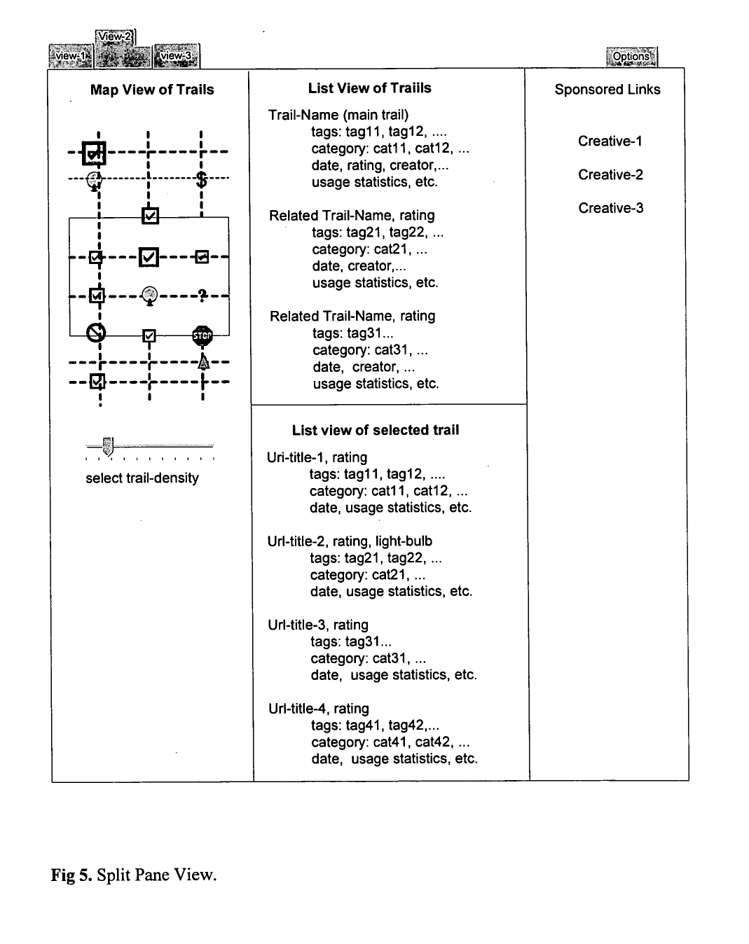

Please refer to FIG. 5. On a search, or browse, the system may show several types of views. For example,
A list view
A map view
A split pane: one showing trail and related trails as a map/xy-plot, the other showing the same data as a list of trails, and a detailed pane for contents of selected trail.
Color code for trail's rating/importance.
Node/Resource shape/size could indicate rating.
Trail creator's icon may be placed on xy-plot, as well as on the list view.
Trailster who added the node to the trail first—their icon may be shown on details view.

To help identify a trail:

each user has an icon.

each group has an icon.

FIG. 5 shows panes for trail-overlay map, trails in a list view, and detail for the trail selected (list-view). The options button may be used to specify filters and constraints, e.g., filter results by favorite trailsters, and/or groups.

### Tabbed Panes

View-1 may indicate “people who like this trail have liked these other trails (constrained by group filter).”

View-2 may indicate trails that have same subject matter, e.g., as determined by tags, categories, and/or search terms:

Main trail has tags t1, t2, . . . .

Related trails have overlapping tags and are highly related.

Filter by group, and/or favorite trailsters.

For a given subject matter, let's say a user likes what a trailster X has contributed—e.g., in a forum. User may specify the said trailster as a favorite trailster. Subject matter could be specified by a list of tags (in order of importance), and/or categories (system categories or community-suggested categories).

For a trail with a given subject matter, other trailsters could be shown. For example:
favorite trailsters: X={x1, x2, x3 . . . }
highly rated related trailsters in user's groups (with a filter to include or exclude specific groups): Y={y1, y2, y3, . . . }
highly rated related trailsters, public.

The system also lets users censor other trailsters.

Sponsored links are advertisements. In FIG. 5, they are on the panel on the right. They may be alternately, or in addition to, placed as a bottom panel, or a panel at the top.

For advertisements, the system may also offer contextually relevant coupons.

This split-pane UI may be a rich client, a browser extension, or a dynamic html page. If it is created with dynamic HTML, the data may optionally be pre-fetched, or asynchronously fetched for faster response time.

### Shared Search

Consider a system that has the following:

a collection of users.

a collection of groups where each group consists of zero or more users.

a collection of trails, where each trail is a collection of resources.

Users share trails and/or individual resources with other users and groups.

A user searching for information, may choose to search for trails and resources, restricting results to those that have been shared with said user. Also, she may optionally, apply zero or more of the following constraints:

restrict results to those created by zero or more specific users.

restrict results to those shared with zero or more specific groups.

restrict result to those shared with zero or more specific users.

restrict results to those created by or shared with specific users.

Current Search Engines provide a shorthand for restricting results from a given website. For example, the following search query:

on duplicate key site:mysql.com

will return all results that match the query string

on duplicate key

from the site mysql.com

The shared-search system in the current embodiment also provides a similar short hand notation for restricting results created by, or shared with specific users, or shared with specific groups. For example:

on duplicate key group:dbguru

will search all resources and trails that have been shared with the group dbguru. Similarly:

on duplicate key users:jane,joe,Jason

will restrict results to those created by or shared with users jane, joe, and jason.

The current embodiment also provides the standard boolean operations that Apache SOLR provides.

### Distance Metrics Amongst Resources—Discovering Related Resources

Trails may also be used as input to compute degree of relatedness, or distance amongst resources.

For the case when two resources r1 and r2 are in the same trail, one may assign a distance of 1 between r1 and r2.

If, however, r1 occurs in many trails, with many other resources, then should the distance between r 1 and all these others still be 1? The answer depends on what the distance measure is used for.

One important application of a distance measure between resources is for a system to show related resources.

In this case, it's more appropriate to use a statistical measure such as affinity [Berry-Linoff 1997, pp 124-156]. For example,

let each trail be a market basket;

compute affinity between resource pairs using market basket analysis.

Market Basket Analysis is the example in the current embodiment. Other methods are also possible.

Using related trails, i.e., trails that meet a specified overlap criteria in resources, and other potential criteria (e.g., minimum rating thresholds), we get a distance measure of 2 between resources that are not in the same trail, but are in related trails.

Similarly, if related trails are pair-wise coalesced into market baskets, one may obtain affinity measures between the resources. Since affinity must be greater than 1 for positive correlation between resources, the system may use 1/affinity (or some other inverse proportional formula) as its distance measure.

Next, if the system is asked to show related resources, it may apply one of the several possible distance measures to sort resources by distance. Or, the system can use rules that combine distance measures. For example, it may order by direct distance (same trail [symbol] distance is 1, etc.) first, next by affinity, but include only those resources that have a minimum threshold rating, and have occurred at least N times across all trails.

The above approach may be generalized to trails at a distance of 3, or more. However, the quality of relatedness may drop off (depends on the trails).

Analyzing high quality trails, the system is able to return related resources that are far superior in quality than was previously possible in the literature.

In the foregoing specification, embodiments of the invention have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### REFERENCES

Berry-Linoff 1997: Berry, M. J. A, and Linoff, G, “Data Mining Techniques,” John Wiley and Sons, 1997.

Delicious: http://del.icio.us
Experuse: (our system for leveraged search; currently in private beta at http://xu2.no-ip.org:42042)
Google Notebook: http://www.google.com/notebook
Medium: http://me.dium.com
StumbleUpon: http://www.stumbleupon.com
Trailfire: http://www.trailfire.com
Trexy: http://www.trexy.com

We claim:

1. A method of automatically identifying related resources, the method comprising:
(a) providing:
a collection of trails, where each trail is a collection of resources.
some of the resources within trails having globally unique identifiers associated with them.
rules for deciding when two trails with overlapping resources are similar.
one or more input trails containing lists of resources on the subject matter of interest.
(b) finding trails similar to input trails by applying the rules in (a) to the collection of trails in (a).
(c) deriving related resources by comparing resources in (b) with those in the input trails.

2. A method of claim 1, wherein step (a) additionally includes trails with ratings, including explicit ratings from users and those derived algorithmically.

3. A method of claim 1, wherein step (a) additionally includes resources with ratings, including explicit ratings from users and those derived algorithmically.

4. A method of claim 1, wherein step (b) additionally includes numerical strengths for similarity between input trails and discovered trails.

5. A method of claim 1, wherein the globally unique identifies for resources in step (a) includes URLs, patent ids, ISBN numbers, product SKUs, and other uniquely identifiable ids.

6. A method of claim 1, wherein step (c) additionally includes resources that have been de-duped—i.e., if two or more resources with different globally unique identifiers refer to the same content, they are normalized and assigned one unique id

7. A method of searching for shared resources and trails, the method comprising:
(a) providing:
a collection of users.
a collection of groups where each group consists of zero or more users.
a collection of trails, where each trail is a collection of resources.
some of the resources within trails having globally unique identifiers associated with them.
(b) generating data: via users sharing trails and/or individual resources with other users and groups.
(c) users searching for trails and/or individual resources, restricting results to those that have been shared with said user, and zero or more of the following constraints:
created by zero or more specified users.
shared with zero or more specified groups.
shared with zero or more other users.

8. A method of claim 7, wherein the search expression specification additionally provides for a language to describe the users and/or groups as part of the search expression.

9. A method of claim 8, wherein the language includes the format:
[G] SEP [groupId], and/or
[G] SEP [groupIds with separator], and/or
[UC] SEP [userId], and/or
[UC] SEP [userIds with separator], and/or
[UR] SEP [userId], and/or
[UR] SEP [userIds with separator], and/or
[U] SEP [userIds with separator], and/or
where
[G] is notation for a string representing a group with who resource or trail is shared;
[UC] is notation for a string representing a user who shared the resource or trail;
[UR] is notation for a string representing a user with whom resource or trail is shared;
[U] is notation for a string representing a user who either shared resource or trail, or with whom resource or trail is shared;
SEP is notation for a separator string.
userIds with separator represent a list of users with separator; e.g., comma separated values.
groupIds with separator represent a list of groups with separator.

10. A method of determining similarity distance measure between two resources, the method comprising:
(a) providing a collection of trails, each consisting of zero or more resources, and some of the resources having globally unique identifiers.
(b) for each resource with a globally unique id, identifying trails they are contained in.
(c) for each resource in (b), marking other resources in the same trail as siblings.
(d) finding trails that are related to trails in (b).
(e) assigning distance measures to intra-trail resources, where the distance measure is optionally based on properties of trails and their resources, including trail and resource ratings.
(f) assigning distance measures to inter-trail resources, where the distance measure is optionally based on properties of trails and their resources, including trail and resource ratings.

11. A method of claim 10, wherein (e) additionally includes statistical measures to determine the distance when resource-pairs appear together in multiple trails.

12. A method of claim 10, wherein (f) additionally includes statistical measures to determine the distance when resource-pairs appear together multiple times across different trails.

13. A method of claim 10, wherein (f) additionally includes formulae using distances of resources with siblings, where a sibling is as defined in 10c.

14. A method of claim 10, wherein (e) or (f) additionally include rules combining different types of distance measures and/or properties of resources (e.g., minimum threshold rating for each resource; require that each resource considered occur at least N times across all trails; etc.).

15. A method of claim 10, wherein similar resources are displayed for a given resource, e.g., on a search result, or on the sidebar of a web browser, etc.

16. A method of claim 10, wherein similar trails are displayed for a given resource, e.g., on a search result, or on the sidebar of a web browser, etc.

17. A method of claim 10, wherein similarity measures are used to determine which resources are dissimilar, e.g., in order to return different types of results on a search query.
